(19) United States
(12) Patent Application Publication
(10) Pub. No.: US 2023/0042260 A1
(43) Pub. Date: Feb. 9, 2023

(54) SUBASSEMBLY INCLUDING A WHEEL HUB AND A CONSTANT VELOCITY JOINT

(71) Applicant: AKTIEBOLAGET SKF, GOTEBORG (SE)

(72) Inventors: Tom SCHMITZ, Hambach (DE); Klaus Dietmar RIPPSTEIN, Ebelsbach (DE); Lisa BAIERL, Schweinfurt (DE); Volker WENDT, Üchtelhausen/Zell (DE)

(21) Appl. No.: 17/874,396

(22) Filed: Jul. 27, 2022

(30) Foreign Application Priority Data
Aug. 5, 2021 (DE) 102021208490.7

(51) Int. Cl. B60B 27/00; B60B 27/02; F16D 3/16; F16D 3/84; B23K 20/12

(52) U.S. Cl. CPC B60B 27/0036; B60B 27/02; F16D 3/16; B60B 27/0094; F16D 3/84; B23K 20/12; B60B 2310/3025

(57) ABSTRACT

A subassembly includes a wheel hub and a constant velocity joint having a bell in which the wheel hub is connected to the bell by friction welding. A first one of the wheel hub and the bell may include an axial projection and the other one of the wheel hub and the bell may include a recess in which the axial projection is received. Also a method of connecting a wheel hub to a constant velocity joint by friction welding.

### CROSS-REFERENCE

This application claims priority to German patent application no. 10 2021 208 490.7 filed on Aug. 5, 2021, the contents of which are fully incorporated herein by reference.

### TECHNOLOGICAL FIELD

The present invention relates to a subassembly including a wheel hub and a constant velocity joint that are connected by friction welding.

### BACKGROUND

As a rule, known constant velocity joints for wheel hubs are non-rotatably connected to a knuckle of the wheel hub, wherein various connection types can be used. For example, radial and/or axial gearings or toothed-shaft connections can be used that are secured with the aid of nuts.

However, with these known connection types the toothed-shaft connections on the one hand and the securing nuts on the other hand occupy a space, so that possible space savings for the wheel hub and constant velocity joint subassembly are limited by the presence of the toothed-shaft connections and the securing nut. In addition, the toothed-shaft connections and securing nuts represent further components whose assembly involves time and costs. Furthermore, each additional element that is installed contributes to the total weight of the assembly.

### SUMMARY

It is therefore an aspect of the present disclosure to provide a subassembly made of a wheel hub and a constant velocity joint that is lighter, smaller and more favorable to manufacture.

In the following a subassembly is disclosed that includes a wheel hub and a constant velocity joint having a bell. The wheel hub and/or the bell are preferably hollow so that the entire subassembly has less weight.

In order to both reduce the manufacturing costs and make the subassembly more space-saving and lighter, the wheel hub is connected to the bell by friction welding. Furthermore, friction welding has the advantages that a so-called heat influence zone is significantly smaller than with other welding methods and that the formation of melts in the joint zone does not occur.

“Friction welding” is understood to mean a welding method in which two parts are moved relative to each other under pressure with the parts in contact at contact surfaces. Heating and plasticizing of the material results due to the arising friction. A very fine-grained structure is produced with very good strength properties of the connecting point. A variety of materials can be welded to each other in this manner, such as, for example, aluminum to steel. The connecting of metallic materials that undergo no alloying with each other is also possible in many cases.

According to a further preferred embodiment, the subassembly further includes a rolling-element bearing unit including at least two rows of rolling elements, wherein the wheel hub is configured as an inner ring for the rolling-element bearing unit and includes at least one first inner raceway for one row of the rolling elements, and the bell is configured as an inner ring for the rolling-element bearing unit and includes a second inner raceway for a second row of the rolling elements. This makes it possible to reduce the number of components since a separate inner ring element between the wheel hub and the bell can be omitted.

Furthermore, either the bell or the wheel hub can include an axial projection that extends to the respective other component, i.e., the wheel hub or the bell, and wherein the other component can include a corresponding opening so that when the bell and the wheel hub are connected, the projection is received in the opening. The projection is preferably configured to shield a friction-welding zone in the radial direction, so that a spark and/or material ejection that can arise during the friction welding is advantageously kept away from the raceways of the rolling-element bearing unit. In addition, a depth of the opening and/or a length of the projection can be selected such that they determine a prescribed bearing clearance or preload of the rolling-element bearing unit. The preload of the rolling-element bearing unit can thereby be easily set.

Furthermore, a seal assembly for the constant velocity joint can be disposed on the wheel hub or the bell. In particular, the seal assembly can be configured for sealing the constant velocity joint or for spacing the constant velocity joint with respect to the interior of the wheel hub. The seal assembly is preferably manufactured from plastic and/or metal.

According to a further aspect, a method is described for manufacturing the subassembly described above, wherein the method includes connecting the wheel hub to the bell by friction welding.

The method preferably also comprises setting the preload of the rolling-element bearing unit during the friction welding.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a subassembly according to a first embodiment of the present disclosure.

FIG. 2 is a detail of the subassembly of FIG. 1.

FIG. 3 is a detail of a subassembly according to a second embodiment of the present disclosure.

### DETAILED DESCRIPTION

In the following, identical or functionally equivalent elements are designated by the same reference numbers.

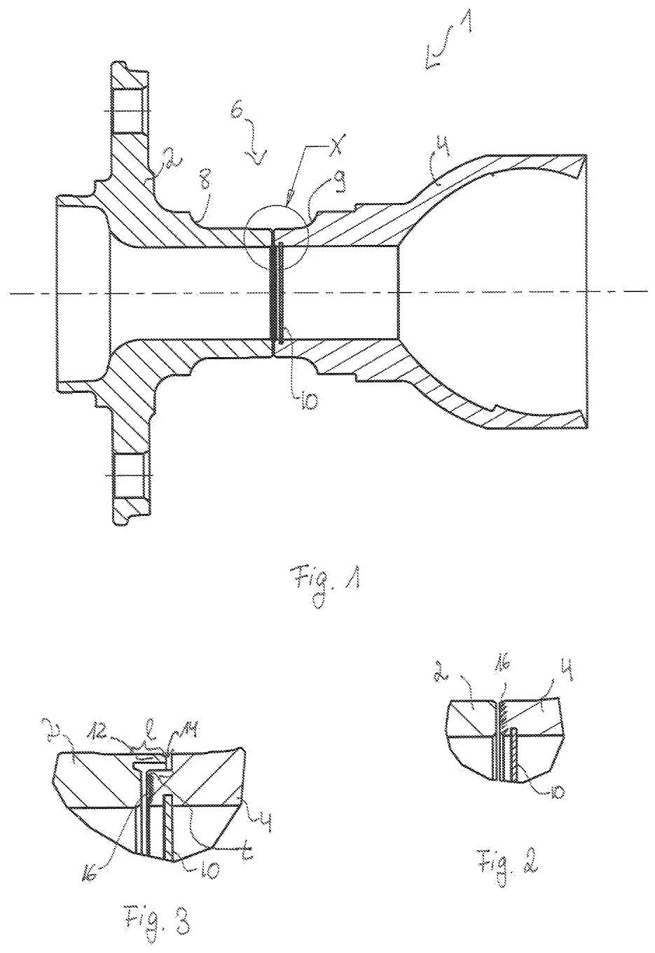

FIG. 1 shows a subassembly 1 according to a first embodiment, including a wheel hub 2 and a constant velocity joint (only partially shown) that includes a bell 4. FIG. 2 shows a detail X of the subassembly at a larger scale. The wheel hub 2 and the bell 4 are preferably hollow so that the entire subassembly 1 is more lightweight. The wheel hub 2 is connected to the bell 4 by friction welding.

The subassembly 1 further includes a rolling-element bearing unit (not shown) including at least two rows of rolling elements (not shown), wherein the wheel hub 2 is configured as an inner ring for the rolling-element bearing unit and includes at least one first inner raceway 8 for one row of the rolling elements, and the bell 4 is configured as inner ring for the rolling-element bearing unit and includes a second inner raceway 9 for a second row of the rolling elements.

Furthermore, a seal assembly 10 for the constant velocity joint is disposed on the bell 4, and the seal assembly 10 is configured to seal the constant velocity joint and/or to space the constant velocity joint with respect to the interior of the wheel hub 2. The seal assembly 10 is preferably manufactured from plastic and/or metal. Alternatively the seal assembly 10 can also be disposed on the wheel hub 2.

FIG. 3 shows a section of a subassembly 1 according to a second embodiment. In comparison to the first embodiment that is shown in FIGS. 1 and 2, the subassembly 1 of FIG. 3 additionally includes an axial projection 12 that is formed on the wheel hub 2 and extends toward the bell 4. Furthermore, a recess 14 is provided on the bell 4 that is configured to at least partially receive the projection 12. Alternatively it is also possible to provide the projection 12 on the bell 4 and the recess 14 on the wheel hub 2.

In particular, the projection 12 is configured such that when the bell 4 and the wheel hub 2 are connected after the friction welding, the projection 12 is received in the recess 14. For example, the projection 12 is configured to shield a friction-welding zone 16 in the radial direction so that a spark and/or material ejection that can arise during the friction welding is kept away from the raceways 8, 9, of the rolling-element bearing unit.

Furthermore, a depth t of the opening 14 and a length l of the projection 12 are configured to determine a prescribed bearing clearance or preload of the rolling-element bearing unit, so that the bearing clearance or preload of the rolling-element bearing unit can be set during the friction welding.

In summary, a subassembly is provided that includes a wheel hub 2 and a bell 4 of a constant velocity joint, wherein the wheel hub 2 and the bell are connected to each other via friction welding. Toothed-shaft connections and securing nuts for connecting the wheel hub and the bell can thereby be omitted, whereby weight can be saved with the subassembly, and additional installation space that was previously occupied by the toothed-shaft connections and securing nuts is free. In addition, the bell 4 and/or the wheel hub 2 can be configured hollow, so that additional weight can be saved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved subassemblies that include a wheel hub and a constant velocity joint.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Subassembly
2 Wheel hub
4 Bell
8, 9 Inner raceway
10 Seal assembly
12 Projection
14 Opening
16 Friction welding zone
t Depth
l Length

What is claimed is:

1. A subassembly comprising:
a wheel hub; and
a constant velocity joint having a bell,
wherein the wheel hub is connected to the bell by friction welding.

2. The subassembly according to claim 1,
further including a rolling-element bearing unit including a first row of rolling elements and a second row of rolling elements,
wherein the wheel hub is configured as an inner ring for the rolling-element bearing unit and includes at least one first inner raceway for the first row of rolling elements, and
wherein the bell is configured as an inner ring for the rolling-element bearing unit and includes a second inner raceway for the second row of rolling elements.

3. The subassembly according to claim 1,
wherein the bell includes an axial projection and the wheel hub includes a recess or the wheel hub includes the axial projection and the bell includes the recess, and
wherein the recess and the axial projection are configured such that when the bell and the wheel hub are connected, the projection is received in the opening.

4. The subassembly according to claim 3,
wherein the wheel hub and the bell are connected at a friction-welding zone, and
wherein the projection is configured to radially overlie the friction-welding zone.

5. The subassembly according to claim 3, wherein a depth of the opening and a length of the projection determine a prescribed preload of the rolling-element bearing unit.

6. The subassembly according to claim 1, wherein the wheel hub and/or the bell are hollow.

7. The subassembly according to claim 1,
including a seal assembly for the constant velocity joint disposed on the wheel hub or on the bell.

8. The subassembly according to claim 7, wherein the seal assembly is manufactured from plastic and/or metal.

9. The subassembly according to claim 1,
wherein the wheel hub includes at least one first inner raceway for a first row of rolling elements, and
wherein the bell includes a second inner raceway for a second row of rolling elements.

10. A method for manufacturing a subassembly comprising:
connecting a wheel hub to a bell of a constant velocity joint by friction welding at a friction-welding zone.

11. The method according to claim 10, including setting a preload of the rolling-element bearing unit during the friction welding.

12. The method according to claim 10,
wherein the wheel hub includes an axial projection and the bell includes a recess,
the method including performing the friction welding while the axial projection is received in the recess.

13. The method according to claim 12,
wherein the friction welding zone is located on an axially facing surface radially inward of the axial projection.

14. The method according to claim 10,
wherein the bell includes an axial projection and the wheel hub includes a recess,
the method including performing the friction welding while the axial projection is received in the recess.

15. The method according to claim 14,
wherein the friction welding zone is located on an axially facing surface radially inward of the axial projection.
